(19) United States
(12) Patent Application Publication
(10) Pub. No.: US 2009/0256713 A1
(43) Pub. Date: Oct. 15, 2009

(54) NETWORK COMPRISED OF SENSOR ELEMENTS

(75) Inventors: Peter Kalisch, Nürnberg (DE); Thomas Diehl, Nürnberg (DE)

Correspondence Address: SCULLY SCOTT MURPHY & PRESSER, PC, 400 GARDEN CITY PLAZA, SUITE 300, GARDEN CITY, NY, 11530, US

(73) Assignee: DIEHL STIFTUNG & CO. KG, Nurnberg (DE)

(21) Appl. No.: 11/936,889

(22) PCT Filed: May 9, 2006
(86) PCT No.: PCT/EP2006/004297

§ 371 Date: Nov. 8, 2007

(30) Foreign Application Priority Data
May 21, 2005 (DE) 10 2005 023 485.2
Jun. 10, 2005 (DE) 20 2005 009 115.4

(51) Int. Cl. G08B 21/00

(52) U.S. Cl. 340/627

(57) ABSTRACT

A network consisting of sensor elements (7-12), in which the sensor elements (7-12) are connected to one another and/or to a central unit (21) by interfaces, the sensor elements (7-12) being arranged at different locations and each having at least one sensor which detects biological or chemical harmful substances, the sensor elements (7-12) having sensors which detect different substances being arranged at different locations, and the sensor elements (7-12) forwarding measured values detected by the sensors to one another and/or to the central unit (21).

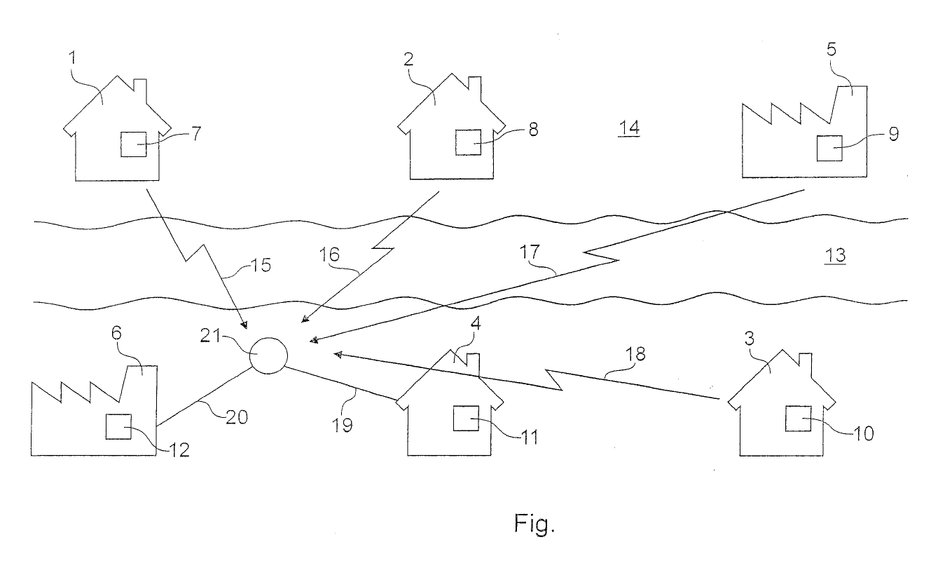

The invention relates to a network comprised of sensor elements which are connected to one another and/or to a central unit by means of interfaces.

Such networks are known, for example, from the determination of consumption data. For example, U.S. Pat. No. 4,553,094 describes a radio network for collecting and transmitting billing-related consumption data (as regards water, power, gas, heat, sewage etc.) of consumers whose residences are distributed over wide areas, in which the consumers in such sparsely populated regions do not have to be individually found in order to read measuring devices. In this case, each terminal containing the corresponding measuring devices has a radio link to data collectors in order to transmit its measured data. These data collectors forward the billing-related consumption data which have been collected to a control center for further processing and billing.

DE 101 52 554 A1 also describes a radio network for transmitting data from a multiplicity of consumption-registering terminals (for example in apartments in a multiple dwelling) which are operated in a distributed manner to a plurality of data collectors (for example on different floors of the staircase of that residential development) and on to a master data collector (for example in the central equipment room or at the entrance to the estate of that development) which also performs central coordination functions.

On the basis of said prior art, the invention is based on the object of proposing a network which has as simple and robust a design as possible and a corresponding use of this network, which can be used to determine the occurrence of harmful substances in a geographical area.

This object is achieved by means of a network having the features of patent claim 1 and by means of a use of this network as claimed in patent claim 9.

Advantageous refinements and developments of the invention are described in the dependent claims.

The fundamental concept of the invention is that sensor elements which contain sensors and are connected to one another and/or to a central unit of the network by means of interfaces are arranged at different locations, the sensors used respectively being sensitive to different biological or chemical harmful substances and poisons. The measurement results from the sensors are forwarded from sensor element to sensor element and/or to the central unit, in which case, as regards the use of the network according to the invention, provision is made for the measured values from the sensors, which relate to different harmful substances, to be evaluated in an overall view and for a decision regarding the triggering of an alarm message to be made on the basis of the result of this overall view.

In a refinement of the invention, the sensor elements are arranged in buildings which are preferably different and are at a distance from one another locally. They may also be connected to consumption meters or integrated in consumption meters. For example, the network can be designed in such a manner that the sensor of at least one sensor element detects harmful substances in water, in particular in the supply of drinking water, and is preferably arranged in a water meter. Another sensor of at least one sensor element may also detect harmful substances in gases such as air or natural gas and may preferably be arranged in a gas meter.

According to a development of the invention, the sensor elements are connected to one another and/or to the central unit in a wireless manner (preferably using radio) and/or in a wired manner (preferably using telephone or power supply lines). The wired connection can be configured using fiber optic cables.

Provision may also be made for the central unit to be an alarm center or to be connected to an alarm center to which the measured values detected by the sensors are forwarded for the purpose of further processing and, if appropriate, for triggering an alarm message.

As regards the use of the network according to the invention, a refinement may provide for the decision threshold for triggering an alarm message to be lower when one type of harmful substance is detected by a plurality of sensors which are arranged at a distance from one another locally (and are sensitive to the same harmful substance or a similar harmful substance) or when a plurality of different types of harmful substances are detected than when only one type of harmful substance is detected by one sensor or a few sensors.

According to a development of the invention, the alarm message is output only for part of the area being monitored, for the entire area being monitored or else for a (larger) area that goes beyond the area being monitored in accordance with the overall view of the measured values from the sensors.

The drawing is used to explain one exemplary embodiment of the invention in more detail. The single FIGURE diagrammatically shows a network having sensor elements which are accommodated in different buildings and are intended to detect biological or chemical harmful substances and poisons.

Sensor elements 7 to 12 are accommodated in residential buildings 1 to 4 and industrial and/or office buildings 5 and 6. The buildings 1 to 6 are distributed over a relatively large geographical area 14 along a road or a route 13 and thus cover this area 14 in metrological terms.

The sensor elements 7 to 12 are connected to a central unit 21 by means of radio links 15 to 18 and wire or fiber optic cable connections 19 and 20. Additionally or alternatively, the sensor elements may also be connected to one another in a wired or wireless manner. Provision may also be made for the central unit 21 to be accommodated in one of the buildings 1 to 6 or for one of the sensor elements 7 to 12 to concomitantly undertake the role of the central unit 21.

Sensors which are sensitive to biological and chemical harmful substances and poisons (these should also be understood as meaning radioactive substances) are arranged in the sensor elements 7 to 12. These include (in a list which is not conclusive) sensors for measuring the pH or the electrical conductivity of water, the concentration of chlorine, the turbidity in liquids and gases, the oxidation or reduction potential, ammonium, chlorides or nitrates, toxic materials (toxins), bacteria or viruses or electromagnetic radiation (α, β or γ radiation).

The sensors may operate in accordance with physical, chemical, biological or microbiological methods. In this case, the occurrence, the identification and the quantity (concentration) of the corresponding harmful substances and poisons can be monitored continuously. Alternatively—in particular in the case of biological and microbiological measurement methods—it may also be necessary to carry out individual measurements (for example at certain intervals of time or at particular points in time), after which the corresponding sensors can be replaced manually or automatically (for example using a refill battery).

It is now provided that the individual sensors which are accommodated in the buildings 1 to 6 are not sensitive to all harmful substances or poisons but rather that each sensor in the sensor elements 7 to 12 respectively detects or identifies only one or, if appropriate, some of the harmful substances to be monitored. The sensor elements 7 to 12 can thus be of a relatively simple and robust design.

The sensor elements 7 to 12 are connected to consumption meters or are integrated in the latter, thus making it possible to design the network in a particularly simple manner since devices such as water or gas meters which already exist in the buildings 1 to 6 can be used to design the monitoring network. In this case, sensors which detect harmful substance concentrations in liquids are arranged on or in water meters (possibly also on or in sewage meters), while sensors which determine harmful substance concentrations from or in gases are arranged in gas meters, ventilation or air-conditioning systems or the like.

The measured values determined by the sensors are forwarded from the sensor elements 7 to 12 to the central unit 21. An overview of the occurrence of all harmful substances to be monitored is thus produced only there. The measured values from the different sensors are then also evaluated here and a decision is made as to whether an alarm message (optically or acoustically locally in the central unit 21 to the sensor elements 7 to 12 or else to a superordinate alarm center) is output on the basis of the evaluation.

Provision may now be made for an alarm message to be output if the measured value for a type of harmful substance to be monitored is above a particular threshold value. If, in a relatively large network, there are a plurality of sensors which are sensitive to the same type of harmful substance, a local alarm may be triggered when the harmful substance concentration threshold value is exceeded at only one of these sensors, whereas a general (“global”) alarm is triggered when this threshold value is exceeded in a plurality of or in all of the sensors which are sensitive to this type of harmful substance. Moreover, if a plurality of types of harmful substance are measured in an impermissibly elevated concentration, a (local or global) alarm can be triggered even when relatively low harmful substance concentration threshold values are exceeded. The exceeding of a relatively low harmful substance concentration threshold value at a plurality of sensors which respond to the same type of harmful substance also suffices to trigger an alarm, the threshold being able to be lower, the greater the number of sensors detecting the corresponding concentration.

Provision may additionally be made for the central unit 21 to also transmit, to each of the sensor elements 7 to 12, the measured values determined by the sensors in the respective other sensor elements 7 to 12, with the result that it is possible to obtain an overview of the harmful substance concentrations detected inside the network at any of the sensor elements 7 to 12. It goes without saying that the same is likewise possible when the individual sensor elements 7 to 12 are connected to one another and can interchange data with one another and can forward data to one another.

Even if only one sensor element 7 to 12 is accommodated in each of the buildings 1 to 6 in the exemplary embodiment described, provision may also or additionally be made for a plurality of sensor elements having one respective sensor or else one sensor element having a plurality of sensors or else a plurality of sensor elements having a plurality of sensors to be accommodated inside a (larger) building.

The extent of the geographical area 14 may be a few 100 meters, preferably a few or several kilometers or else several 100 kilometers.

The network according to the invention is also used, in particular, in so-called homeland security, that is to say to protect national territory or one or more parts of national territory against war or, in particular, terrorist encroachments or attacks. In this case, all kinds of weapons are also considered to be harmful substances in the sense of the invention.

1. A network comprising sensor elements (7-12) which are connected to one another and/or to a central unit (21) by interfaces,
the sensor elements (7-12) being arranged at different locations and each having at least one sensor for detecting biological or chemical harmful substances, said sensor elements (7-12) having sensors which detect different substances being arranged at different locations, and
the sensor elements (7-12) forwarding measured values detected by the sensors among each other and/or to the central unit (21).

2. The network as claimed in claim 1, wherein
the sensor elements (7-12) are arranged in buildings (1-6) which are different and are at locales distant from one another.

3. The network as claimed in claim 1 wherein
the sensor elements (7-12) are connected to consumption meters or are integrated in consumption meters.

4. The network as claimed in claim 1, wherein
the sensor of at least one said sensor element (7-12) detects harmful substances in water, and in the supply of drinking water, and is arranged in a water meter.

5. The network as claimed in claim 1 wherein
the sensor of at least one said sensor element (7-12) detects harmful substances in gases, such as air or natural gas, and is arranged in a gas meter.

6. The network as claimed in claim 5, wherein
the sensor elements (7-12) are connected to one another and/or to the central unit (21) in a wireless manner, preferably using radio, and/or in a wired connection using telephone or power supply lines.

7. The network as claimed in claim 6, wherein
the wired connection of the sensor elements (7-12) to one another and/or to the central unit (21) is configured using fiber optic cables.

8. The network as claimed in claim 1, wherein
the central unit (21) is an alarm center or is connected to an alarm center to which the measured values detected by the sensors are forwarded for further processing and, appropriately, for triggering an alarm message.

9. The network as claimed in claim 1, utilized for monitoring an area (14) for biological or chemical harmful substances, wherein
the measured values from the sensors, which relate to the various harmful substances, are evaluated in an overall view, and enabling a decision be made regarding the triggering of an alarm message on the basis of the result of said overall view.

10. The network as claimed in claim 9, wherein
the decision threshold for triggering an alarm message is lower when one type of harmful substance is detected by a plurality of said sensors which are arranged at a distance from one another locally or when a plurality of different types of harmful substances are detected than when only one type of harmful substance is detected by one said sensor or a few of said sensors.

11. The use as claimed in claim 9 wherein
the alarm message is outputted only for part of the area (14) being monitored, for the entire area (14) being monitored or for an area that extends beyond the area (14) being monitored in accordance with the overall view of the measured values from the sensors.
